(19) United States
(12) Patent Application Publication
(10) Pub. No.: US 2023/0036236 A1
(43) Pub. Date: Feb. 2, 2023

(54) Assembly and installation of solar trackers

(71) Applicant: NEXANS, Courbevoie (FR)

(72) Inventors: Fabien VIENNOIS, Messery (FR); Jérôme TORDO, Aix-En-Provence (FR); Pierre WALTER, Aix-en-Provence (FR)

(21) Appl. No.: 17/778,381

(22) PCT Filed: Oct. 30, 2020
(86) PCT No.: PCT/FR2020/051967

§ 371 Date: May 19, 2022

(30) Foreign Application Priority Data
Nov. 21, 2019 (FR) FR19 12985

(51) Int. Cl. F24S 30/425; H02S 10/00; F24S 25/13

(52) U.S. Cl. CPC F24S 30/425; H02S 10/00; F24S 25/13; H02S 20/32

(57) ABSTRACT

The invention relates to a workshop (18) for the construction of pre-assembled structures for solar trackers, each structure comprising a support beam, at least two stands supporting the beam and each comprising a support cradle, the two cradles being spaced apart by a predetermined inter-cradle distance. The workshop (18) comprises two consecutive assembly zones (Z₁-Z₃), and at least two trolleys (20a, 20b) capable of being moved on the ground, for the construction of a single pre-assembled structure, on rolling tracks (19a, 19b) connecting the zones (Z₁-Z₃) The zones comprise: —an initial assembly zone (Z₁) in which the stands are assembled directly on the trolleys (20a, 20b); and a second assembly zone (Z₂) comprising two locations (23a, 23b) holding the trolleys (20a, 20b) n position for assembly of the support beam onto the cradles while ensuring that the cradles are spaced apart by said predetermined inter-cradle distance.

### TECHNICAL FIELD

The present invention relates in general to the assembly and installation of solar trackers on a free field solar power plant site.

### TECHNOLOGICAL BACKGROUND

A solar tracker comprises a structure which supports solar energy collecting devices, for example photovoltaic panels, and which is rotationally driven by a motorized drive device so that the panels remain constantly oriented facing the sun throughout the day. The objective of such a rotationally mobile structure is to increase the yield of the photovoltaic panels.

As described in particular in document WO 2018/033495 in the name of the Applicant Company, a known structure for a solar tracker comprises a support beam extending along a longitudinal axis and configured to support a table equipped with solar energy collecting devices, and at least two lower parts forming at least a first pedestal and a second pedestal and respectively comprising a first support arch and a second support arch which are configured to support the support beam. The first support arch and the second support arch each extend in a plane perpendicular to the longitudinal axis and are separated from one another by a predetermined inter-arch distance. In order to allow the assembly made up of the support beam and the support arches a rotational movement, the first support arch rests on a cradle of a rotational-drive device, preferably comprised within the first pedestal, and the second support arch rests on a cradle of a rotational-guidance device, preferably comprised in the second pedestal. The support beam may be made up of a single large-diameter longitudinal member fixed to the two support arches, or of a plurality of such longitudinal members connected end to end along the longitudinal axis of the beam. Alternatively, the support beam may be a latticework structure comprising at least two longitudinal members (or longitudinal member sections placed end to end in the case of each of the longitudinal members) extending in a parallel manner along the longitudinal axis of the beam and mechanically connected to one another by crossmembers and tie rods distributed along the longitudinal axis.

Such structures generally have very large dimensions. By way of nonlimiting example, a support beam may have a length (along the longitudinal axis of the beam) of as much as 40 meters and a width of 3.5 meters. The total structure (measured from the bases of the first pedestal and of the second pedestal) may reach a height of 1.5 meters and weigh in excess of 2 metric tons.

A great many (typically from around one hundred to several thousand) solar trackers are generally installed on the one same site of a free field solar power plant more commonly referred to as a “solar farm”.

One of the major concerns is to ensure that the cost of the energy collected by a solar farm is as low as possible. This cost is reduced by increasing the yield of the solar farms, and also by reducing the costs of installing these solar farms.

In order to limit the costs of installing solar trackers in a solar farm, notably in terms of transport, the various components needed for manufacturing each tracker (particularly the cradles, the support arches, the longitudinal members or longitudinal member sections, the crossmembers and tie rods, the solar panels, etc., in the case of the above-described structure) are sourced at the actual location at which the tracker is installed on the solar farm. Technicians therefore travel from location to location to assemble each tracker directly on its associated location. This traditional method of assembly is illustrated schematically in FIG. 1 which depicts, in plan view, an example of a solar farm 1 under construction to accommodate a plurality of solar trackers 2 on dedicated locations 3. The solar farm 1 here comprises two installation zones 1a and 1b separated by a runway track 4. The installation zone 1a is intended in this example to accommodate three rows 5a, 5b and 5c of six solar trackers 2 running parallel to the runway track 4. In the example of FIG. 1, all the solar trackers 2 of row 5a have already been installed on their respective locations 3, just one solar tracker 2 has been installed in row 5b and no tracker has yet been installed in row 5c. The installation zone 1b for its part is intended to accommodate two rows 6a, 6b of six solar trackers 2 running perpendicular to the runway track 4. In the example of FIG. 1, the six solar trackers 2 of row 6b have already been installed, and just one solar tracker 2 has been installed in row 6a. Each installation location 3 for a solar tracker 2 is made up of a pair of foundations 7a, 7b on the ground. The foundation 7a forms a first ground support to accept the first pedestal (not depicted) that supports the mobile structure of the tracker described hereinabove. Likewise, the foundation 7b forms a second ground support to take the second pedestal (not depicted) supporting the mobile structure of this same tracker 2. The foundations are, for example, concrete footings laid on or anchored into the ground.

As mentioned hereinabove, the traditional method of assembly consists in conveying, via the runway track 4, the various components needed for the manufacture of each tracker 2 (these being depicted schematically as diamonds 8 in FIG. 1) to its intended location 3 on the solar farm. The conveying of the various components 8, which is indicated by the arrow F₁, is performed for example in a single batch for all the locations 3 of the same row. Crews of technicians 9 then travel from location to location (arrow F₂) to assemble the components 8 of each tracker 2 directly onto its associated location 3. What is meant by the assembly being “direct” is that the technicians perform the assembly by first of all installing the components of the first pedestal and of the second pedestal of the structure of the tracker (particularly the cradles surmounted by the support arches) directly on the foundations 7a, 7b that respectively form the first ground support and the second ground support. The technicians then assemble the various elements that make up the support structure directly on the support arches. The solar panels are then fixed to rails which are themselves fixed to the support structure. Given the height of the structures (in excess of one meter) plus the height of the foundations 7a, 7b (for example of the order of 0.8 meters), scaffolding (not depicted) has to be erected at each location 3 in order to allow the technicians to assemble the components of the tracker level by level.

This traditional method of assembly is not without a certain number of disadvantages. In particular, the technicians are not working under optimal conditions for assembling the components of a tracker, particularly as they are working at height and in a confined workspace on the scaffolding. Furthermore, they have to travel widely across the site, which adds to their fatigue and increases the risks not only of accidents but also of assembly errors.

### SUMMARY OF THE INVENTION

The present invention proposes improvements to the processes used to assemble structures for solar trackers and for installing these structures on solar farms with the view notably to optimizing the time taken to install them on site, to facilitating the work of the technicians and to ensuring the quality of the assembly.

More particularly, a first subject of the present invention is a workshop for the construction of preassembled structures for solar trackers, each preassembled structure comprising a support beam extending along a longitudinal axis and configured to support a table equipped with solar energy collecting devices and at least two lower parts forming at least a first pedestal and a second pedestal and respectively comprising a first support arch and a second support arch which are configured to support said support beam, the first support arch and the second support arch each extending in a plane perpendicular to said longitudinal axis and being separated from one another by a predetermined inter-arch distance d,

the construction workshop being characterized in that it comprises at least two successive assembly zones, and at least a first carriage and a second carriage which are able to be moved along the ground in the construction workshop for constructing the one same preassembled structure, along, respectively, a first path along a first runway track and a second path along a second runway track, the runway tracks connecting said at least two successive assembly zones, and in that the successive assembly zones comprise:
an initial assembly zone comprising, on the one hand, a first workstation to allow the first pedestal to be assembled directly on said first carriage, the first pedestal after assembly being oriented in such a way that the first support arch extends in a vertical plane parallel to the first path and, on the other hand, a second workstation to allow the second pedestal to be assembled directly on the second carriage, the second pedestal after assembly being oriented in such a way that the second support arch extends in a vertical plane parallel to the second path; and
a second assembly zone comprising a first location on the first path of the first carriage and a second location on the second path of the second carriage, these locations being configured to hold the first carriage and the second carriage respectively in position for assembling the support beam to the first support arch and to the second support arch which are borne respectively by the first carriage and the second carriage, the first and second locations being distant from one another so that when the first carriage and the second carriage are respectively occupying the first and second locations, the first support arch and the second support arch extend in two vertical planes which are separated from one another by said predetermined inter-arch distance d.

According to one possible embodiment, the workshop comprises a first pair of rails and a second pair of rails extending respectively over at least the first location and the second location of the second assembly zone, and the first carriage or, respectively, the second carriage, comprises a first set of wheels which are able to collaborate with the first pair or, respectively, the second pair, of rails to guide the first carriage or, respectively, the second carriage, over the first location or, respectively, the second location.

According to one possible embodiment, the first pair of rails and the second pair of rails extend as far as the initial assembly zone, the first carriage and the second carriage respectively bearing the first pedestal and the second pedestal which are assembled in the initial assembly zone being able to be moved directly as far as the first location or, respectively, second location of the second assembly zone by rolling along their associated pair of rails.

According to one possible embodiment, the first carriage or, respectively, the second carriage, comprises a second set of wheels to allow the carriages to roll along the ground of the workshop when not rolling along their associated pair of rails.

According to one possible embodiment, wherein the support beam of each preassembled structure is a latticework beam comprising three longitudinal members extending in a parallel manner along said longitudinal axis, the second assembly zone comprises a plurality of longitudinal-member support tools distributed on either side of the first location and of the second location along an axis perpendicular to the pairs of rails, each support tool being able to preposition and temporarily hold three sections of longitudinal members in an orientation perpendicular to the pairs of rails.

According to one possible embodiment, each longitudinal-member support tool comprises a U-shaped support piece, which is to say a piece comprising two parallel uprights connected by a horizontal middle branch perpendicular to these.

According to one possible embodiment, said U-shaped support piece is mounted with the ability to pivot on at least one pedestal so as to be able to pivot between a raised position in which the two uprights stand up vertically, and a lowered position in which the two uprights extend substantially horizontally.

According to one possible embodiment, the free ends of the two uprights and the middle branch comprise a housing able to accommodate a section of one of the three longitudinal members when the U-shaped support piece is in the raised position.

According to one possible embodiment, the workshop comprises a third assembly zone, contiguous with said second assembly zone and toward which the first carriage and the second carriage respectively bearing the first pedestal and the second pedestal assembled in the initial assembly zone, and the support beam assembled in the second assembly zone can be moved by rolling simultaneously along the first runway track and the second runway track.

According to one possible embodiment, the workshop comprises a storage zone toward which the first carriage and the second carriage bearing a preassembled structure can be rolled simultaneously.

Another subject of the present invention is an installation for a free field solar power plant site, said installation comprising:
a workshop for the construction of preassembled structures for solar trackers according to the above first subject;
a solar tracker installation zone connected to said construction workshop by at least one on-ground runway track for running along the ground, said installation zone comprising a plurality of locations, each location comprising at least two foundations on the ground forming a first ground support and a second ground support which are able respectively to receive a first pedestal and a second pedestal of a structure preassembled in said construction workshop; and
a lifting and transport implement configured to transport, via said at least one on-ground runway track, a preassembled structure from the construction workshop as far as the installation zone and for placing said preassembled structure directly on the at least two foundations of a location so that the first pedestal and the second pedestal of the preassembled structure rest respectively on the first ground support and the second ground support.

The present invention also relates to a method for installing solar trackers on a site of a free field solar power plant, comprising:
a phase of installing a construction workshop according to the first subject on a dedicated zone of said site;
a phase of constructing preassembled structures for solar trackers in said construction workshop;
a phase of constructing a plurality of locations in a solar tracker installation zone connected to said construction workshop by at least one on-ground runway track, each location comprising at least two foundations on the ground forming a first ground support and a second ground support, which ground supports are able respectively to receive the first pedestal and the second pedestal of a structure preassembled in said construction workshop; and
a transport and installation phase during which a preassembled structure is transported from the construction workshop and placed directly on the at least two foundations by the one same lifting and transport implement which is able to position the first pedestal and the second pedestal of the preassembled structure on the first ground support and the second ground support respectively.

### BRIEF DESCRIPTION OF THE FIGURES

The description which will follow, with reference to the attached drawings given by way of nonlimiting examples, will make it easy to understand what the invention consists of and how it may be embodied. In the attached figures:

FIG. 1, already described hereinabove, schematically illustrates the steps employed for a conventional method of assembling and installing solar trackers in an example of a solar farm in plan view from above;

FIG. 2 illustrates an example of a structure for a solar tracker, preassembled in a construction workshop according to the present invention;

FIG. 3 schematically depicts a plan of one possible embodiment of a construction workshop suited to the preassembly of the structure of FIG. 2;

FIG. 4 schematically depicts an enlarged view of an initial assembly zone of the workshop of FIG. 3;

FIG. 5 illustrates an example of a carriage of the workshop of FIG. 3, bearing a preassembled pedestal of the structure;

FIG. 6 schematically depicts an enlarged view of a second assembly zone of the workshop of FIG. 3;

FIG. 7 illustrates a carriage placed on a dedicated location of the second assembly zone of FIG. 6;

FIG. 8 depicts one possible embodiment of a carriage used in the workshop, according to the invention;

FIG. 9 depicts one possible embodiment of a temporary support tool used in the workshop;

FIG. 10 depicts two views showing the use of the carriage of FIG. 9 for assembling a latticework support beam;

FIG. 11 schematically illustrates, in plan view from above, one example of an installation for a free field solar power plant site according to the present invention;

FIG. 12 depicts an example of a transport and lifting implement suitable for transporting and setting down a preassembled structure;

FIG. 13 depicts the transport and lifting implement of FIG. 12, during transportation of a preassembled structure;

FIG. 14 illustrates an example of a member acting as an interface between a transport and lifting implement and a preassembled structure;

FIG. 15 illustrates steps implemented for a method of assembling and installing solar trackers according to the present invention.

### DESCRIPTION OF EMBODIMENT(S)

In the figures, and unless stated otherwise, elements that are identical or equivalent will bear the same reference signs.

The general principle of the installation of structures of solar trackers on the site of a solar farm according to the invention consists in allowing these structures to be preassembled in the one same construction workshop, preferably situated in the vicinity of or directly on the site of the solar farm. Each preassembled structure can then be conveyed from the workshop to an intended location on the solar farm site where it can be set down directly onto the foundations associated with this location.

One example of a construction workshop particularly well suited to the preassembly of structures will be described in what follows in connection with a particular solar-tracker structure described hereinafter. As will become apparent from reading the description, the features described in connection with the construction workshop can be adapted, without departing from the scope of the invention, to suit any multi-level structure comprising a support beam held by support arches resting on cradles.

Solar Tracker Preassembled Structures

FIG. 2 depicts a nonlimiting example of a solar tracker structure 10 which has been preassembled in a construction workshop in accordance with the principles of the present invention. An orthogonal frame of reference (x, y, z) connected with the structure is depicted in the figure. In what follows, the axis x denotes the direction of longitudinal extension of the preassembled structure.

When the structure is set down on flat ground, the axes x and z are horizontal and the axis y is vertical.

The preassembled structure 10 at its lower level comprises two pedestals, namely:
a first pedestal comprising a cradle 11a of a rotational-drive device surmounted by a first support arch 12a; and
a second pedestal comprising a cradle 11b of a rotation guidance device surmounted by a second support arch 12b.

The preassembled structure 10 further comprises a support beam intended to support photovoltaic panels (which are not depicted). The support beam is a latticework beam comprising an assembly here made up of three longitudinal members 13, 14, 15 which extend parallel to one another along the axis x, and of a great many crossmembers 16 and tie rods 17 distributed along the direction of longitudinal extension to mechanically connect each of the three longitudinal members pairwise. Each longitudinal member is made up of several, for example seven, longitudinal member sections (such as the sections 15′ in the case of the longitudinal member 15) which are assembled end to end along the axis x. The longitudinal members or the longitudinal member sections are preferably made of metal.

As is visible more particularly in FIG. 2, the crossmembers 16 are arranged relative to the three longitudinal members 13, 14 and 15 in such a way as to form a plurality of mutually parallel triangles each contained in a plane perpendicular to the direction of longitudinal extension, or in other words in a plane parallel to the plane of the y and z axes. The triangles here are uniformly distributed along the main direction of extension. As an alternative, provision could be made for the density of triangles to be increased locally in regions of the structure in which it is desirable to increase the mechanical strength, for example at one and/or the other of the first and second support arches 12a and 12b. The tie rods 17 are arranged in such a way as to connect the two vertices of two consecutive triangles.

The structure 10 preassembled in the workshop furthermore preferably comprises elements which are not depicted in FIG. 2, such as:
a plurality of rails fixed transversely along the axis z to the two upper longitudinal members 14 and 15, intended to accept the photovoltaic panels;
a geared motor unit of a rotational-drive device in the region of the cradle 11a.

As visible in FIG. 2, the structure 10 obtained after preassembly in the workshop extends longitudinally over a length L. The first pedestal and the second pedestal are arranged in such a way that the first support arch 12a and the second support arch 12b each extend in a plane perpendicular to the longitudinal axis of the structure, being separated from one another by a predetermined inter-arch distance d which is shorter than the length L. The first support arch 12a and the second support arch 12b are also arranged a certain distance away from the ends of the structure 10. The structure 10 thus cantilevers out from the first support arch 12a on its first pedestal and from the second support arch 12b on its second pedestal, allowing an advantageous distribution of the mechanical stresses borne by the structure 10 to make it possible to reduce the weight and the deformation (sagging) of the structure while at the same time maintaining high mechanical strength.

In one possible embodiment, the preassembled structure 10 may for example have a length L of 32 meters, with an inter-arch distance d equal to 18 meters. In another possible embodiment, the preassembled structure 10 may for example have a length L of 38 meters, with an inter-arch distance d equal to 21 meters. In other embodiments which have not been depicted, the preassembled structure may comprise more than two pedestals, each pedestal having an arch. In that case, several inter-arch distances may be defined, for each consecutive two-pedestal group of the structure.

Construction Workshop for the Construction of Preassembled Structures

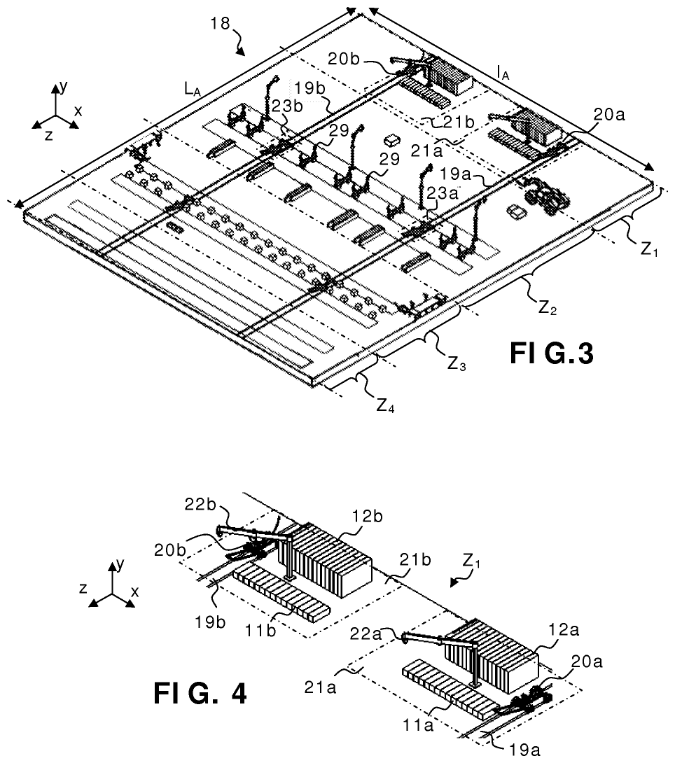

One possible embodiment of a construction workshop 18 according to the invention and that is particularly well suited to the construction of the preassembled structure 10 of FIG. 2 will now be described with reference to FIGS. 3 to 10. For a clear understanding of the connection between the way in which the workshop 18 is organized and the way in which the preassembled structures 10 are configured within this workshop, the orthogonal frame of reference (x, y, z) described hereinabove and connected with the structure 10 of FIG. 2 has been transferred onto some of these figures. Furthermore, in what follows, all the references marked with the suffix “a” indicated in the figures will correspond to the parts and tools of the workshop that are more specifically used for manufacture on the motorized side of the structure (cradle 11a and first support arch 12a) and all the reference marked with the suffix “b” indicated in the figures will correspond to the parts and tools of the workshop that are used more specifically for manufacture on the non-motorized side of the structure (cradle 11b and second support arch 12b).

The construction workshop 18 depicted in FIG. 3 extends over a flat zone, for example a rectangular zone of length LA and width IA greater than the length of the structures 10 once these have been preassembled. In the case of a structure with a length of 38 meters, the construction workshop 18 extends for example over a ground area of a length LA equal to 50 meters and width IA equal to 46 meters.

The workshop 18 is configured here as three assembly zones Z₁ to Z₃ and an optional storage zone Z₄ for storing the preassembled structures. The above four zones extend in the workshop successively along the axis z. The three assembly zones correspond to:
an initial assembly zone Z₁, for assembling the elements that make up the first pedestal and the second pedestal of each solar tracker structure 10;
a second zone Z₂ dedicated to assembling the elements that make up the support beam of each structure 10; and
an optional third zone Z₃ dedicated to the assembly of other elements, such as solar panel support rails.

The workshop 18 further comprises:
two runway tracks 19a, 19b, preferably rectilinear, extending parallel to one another over the length LA (along the axis z) of the workshop in order to connect the zones Z₁ to Z₄ to one another and allow a structure 10 to pass successively from one zone to another as it is being assembled;
carriages used in pairs for assembling the one same solar tracker structure 10, each pair comprising a first carriage 20a and a second carriage 20b which are able to run along the ground of the workshop and in particular respectively along a first path along the runway track 19a and along a second path along the runway track 19b.

The principle of assembly according to the invention is to assemble the various components of each solar tracker structure 10 successively, starting by assembling, in the initial assembly zone Z₁, the first pedestal and the second pedestal of the one same structure directly on the first carriage 20a or, respectively, the second carriage 20b, and then rolling the two carriages 20a, 20b successively as far as the zones Z₂ and Z₃ to continue with the assembling of the components of the structure, and then on to the zone Z₄ to store each preassembled structure.

The initial assembly zone Z₁ comprises, as visible in FIG. 3 and more particularly visible in the enlarged view of FIG. 4, a first workstation 21a (depicted schematically in broken lines) suited to allowing a technician (not depicted) on the ground to assemble the first pedestal directly on the first carriage 20a, and a second workstation 21b suited to allowing this technician (or another technician) on the ground to assemble the second pedestal of the structure directly on the second carriage 20b. Each of these workstations 21a, 21b extends transversely with respect to its associated runway track 19a or, respectively, 19b, and preferably comprises:
a zone for the storage of the cradles 11a or 11b and a zone for the storage of the arches 12a or 12b used for assembling the first pedestal or the second pedestal of each structure;
a lifting arm 22a or 22b to assist the technician in lifting a cradle 11a or 11b and then an arch 12a, 12b in order to place these on the associated carriage 20a or 20b;
zones, not depicted, for storing other elements such as the screws and the necessary tooling (for example power screwdrivers) for assembling a support arch 12a, 12b on its cradle 11a, 11b.

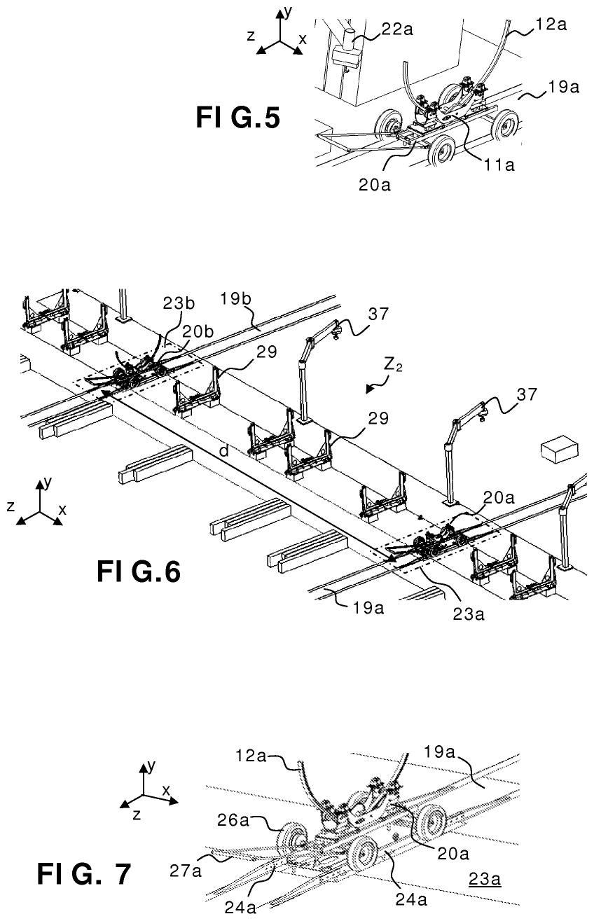

As visible in particular in FIG. 5, the first pedestal after assembly (cradle 11a supporting the first arch 12a) is oriented on the first carriage 20a so that the first support arch 12a extends in a vertical plane parallel to the first path of the first carriage 20a on the runway track 19a. Similarly (not depicted), the second pedestal after assembly is oriented such that the second support arch 12b extends in a vertical plane parallel to the second path of the second carriage 20b.

Each carriage 20a, 20b can then be moved as far as the second assembly zone Z₂ along its path on the associated runway track 19a, 19b.

The second assembly zone Z₂ comprises, as depicted schematically in broken lines in FIG. 3, and more particularly visible in the enlarged view of FIG. 6, two specific locations 23a, 23b and, more specifically:
a first location 23a on the path of the first carriage 20a on the runway track 19a, and
a second location 23b on the second path of the second carriage 20b on the runway track 19b.

These two locations 23a, 23b are configured to hold the first carriage 20a or, respectively, the second carriage 20b, in position for assembling the support beam to the first support arch 12a and to the second support arch 12b which arches are borne respectively by the first carriage 20a and the second carriage 20b. In particular, the first location 23a and the second location 23b are parallel to one another (along the axis z) and distant from one another (along the axis x) such that when the first carriage 20a and the second carriage 20b are respectively occupying the first and second locations, the first support arch 12a and the second support arch 12b extend in two vertical planes separated from one another by the inter-arch distanced predetermined for the structure 10.

In order to ensure compliance with this inter-arch distance d, the workshop 18 advantageously comprises two pairs of rails extending respectively over the first location 23a and over the second location 23b, the center-distance between the two pairs of rails being precisely set in order to obtain a separation of magnitude d between the first arch 12a and the second arch 12b. More specifically, the workshop 18 comprises:
as visible in FIG. 7, a first pair of rails 24a extending over the first location 23a and on which the first carriage 20a is able to run, and
a second pair of rails similar to the first pair of rails, extending over the second location 23b, and on which the second carriage 23b is able to run.

The rails 24a and 24b are preferably provided with slopes at their ends to make it easier for the carriages 20a, 20b to mount and descend from their associated pair of rails.

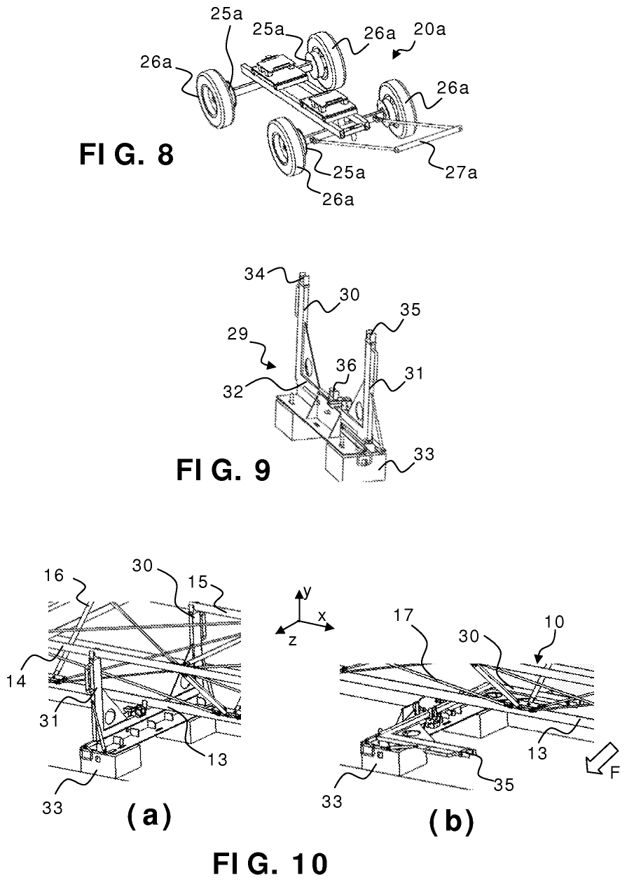

Each carriage 20a and 20b comprises a first set of wheels which are able to collaborate with the associated pair of rails 24a or 24b to guide the carriage over its associated location 23a, 23b in the second zone Z₂. Thus, the carriage 20a illustrated in FIG. 8 comprises four wheels 25a designed to run along the rails 24a. The four wheels 25a are preferably made of metal.

Each carriage 20a and 20b also comprises a second set of wheels, preferably tires, to allow the carriages to run along the ground of the workshop 18 when not running on their associated pair of rails. FIG. 8 shows for example the carriage 20a equipped with four tires 26a. The tires 26a are arranged in pairs, with a rear pair connected by a rear axle and a front pair connected by a front axle. The wheels 25a are also arranged in pairs on the front axle and on the rear axle, and placed concentrically with respect to the tires on the inboard side of the axle. As visible in FIG. 7, when the first carriage 20a is over its location 23a, the wheels 25a are on the rails 24a.

Each carriage 20a and 20b advantageously comprises a handle (27a in the case of the carriage 20a of FIG. 8) allowing an individual to pull the carriage along the ground of the workshop 18 and on its associated pair of rails.

In an alternative form, not depicted, of a workshop according to the present invention, the pairs of rails could extend upstream as far as the zone Z₁ or even over practically the entire length LA of the workshop, and thus make up the runway tracks 19a and 19b that connect the various assembly and storage zones with one another.

Returning to FIGS. 3 and 6, the second assembly zone Z₂ also comprises a plurality (eight in the figures) of longitudinal-member support tools 29 distributed on either side of the locations 23a and 23b along an axis parallel to the axis X (in other words distributed along an axis perpendicular to the pairs of rails provided at the locations 23a and 23b). These support tools 29, placed on the ground, will allow technicians to preposition the seven longitudinal-member sections placed end to end to form each of the three longitudinal members 14, 15, 16 of the structure of FIG. 2 correctly and temporarily with respect to the two arches of the structure before assembling these sections with one another and assembling the longitudinal members to the arches.

FIGS. 9 and 10 illustrate one possible embodiment for a longitudinal-member support tool 29 suitable for the support beam of the three longitudinal-member structure of FIG. 2. FIG. 10 partially illustrates the longitudinal members, tie rods and crossmembers of a structure 10 which is positioned over the tool 29. The tool 29 comprises a U-shaped support piece, which is to say a support piece comprising two parallel uprights 30, 31 connected by a middle branch 32 perpendicular to these. The middle branch 32 extends horizontally, borne by one or more pedestals 33 placed on the ground. The U-shaped support piece is mounted with the ability to pivot on the pedestals 33 so as to be able to pivot between a raised position, illustrated in view (a) of FIG. 10, in which the two uprights 30, 31 stand up vertically, and a lowered position, illustrated in view (b) of FIG. 10, in which the two uprights 30, 31 extend substantially horizontally. The free ends of each upright 30, 31 each comprise a housing 34 or, respectively, 35, intended, when the support piece is in the raised position of FIG. 10 (a), to accept a section of the upper longitudinal member 14 or, respectively, 15. The middle branch 32 also comprises a housing 36 intended, when the support piece is in the raised position of FIG. 10(a), to accept a section of the lower longitudinal member 13. The various longitudinal-member support tools 29 need to be positioned precisely in zone Z₂ of the workshop so as to allow correct prepositioning of the longitudinal-member sections and thereafter correct assembly of the longitudinal-member sections, crossmembers 16 and tie rods 17 that form the latticework beam of the structure 10. As is more particularly visible in FIG. 6, the eight tools 29 are oriented in such a way that their U-shaped pieces extend, in the raised positions, in planes that are vertical and parallel to the rails at the locations 23a, 23b. This ensures that, when the carriages 20a, 20b are in position over their respective location 23a, 23b, the U-shaped pieces will extend in planes that are vertical and parallel to the vertical planes containing the arches of the structure which are borne by these carriages and so that, in consequence, the longitudinal-member sections that are to be assembled will be held temporarily by the tools 29 in an orientation parallel to the longitudinal axis of extension of the structure 10 (or in other words, in an orientation perpendicular to the pairs of rails provided at the locations 23a and 23b). The three housings 34, 35 and 36 of each support tool 29 themselves ensure the separation between each longitudinal-member section.

The prepositioning of the longitudinal-member sections is performed by the technicians preferably using lifting arms 37 positioned in the second zone Z₂ (see FIGS. 3 and 6). The lifting arms 37 are for example magnetic lifting arms fixed to the ground in the second zone Z₂ of the workshop and able magnetically to lift the metal longitudinal-member sections stored in storage zones of the second zone Z₂ and to pivot in order to move each longitudinal-member section from its storage zone into vertical alignment with the corresponding housings 34, 35 or 36 of the support tools 29 in the raised positions. A technician can then manually orient the longitudinal-member section so that it can be accommodated from above in each housing 34, 35 or 36. As in the case of the initial assembly zone zones (not depicted) are provided in the second storage zone for storing the elements necessary for assembling the support beam, such as the screws and the tightening tools. The technicians tasked with assembling the support beam thus have everything they need at their disposal.

Once the longitudinal members, crossmembers and tie rods have been assembled, the structure 10 can be moved toward the third assembly zone Z₃ by means of the two carriages 20a, 20b. To do that, the tools 29 need previously to have been pivoted into their lowered position depicted in view (b) of FIG. 10 so as to allow free passage and allow the two carriages bearing the structure 10 to effect a translational movement in the direction of the arrow F in order to leave the second assembly zone Z₂ and reach the third assembly zone Z₃.

As indicated hereinabove, the third zone Z₃ is dedicated to assembling other elements of the structure, such as the solar panel support rails, the geared motor units for the rotational drive devices, or even possibly the solar panels. This zone will not be described in detail but relies on the same principle of having a layout suited to facilitating the work of the technicians (zone for storage for tools, components, etc.).

The structure in its state of assembly leaving the third zone Z₃ can be conveyed, again using the two carriages 20a, 20b supporting it and rolling along simultaneously, as far as the storage zone Z₄, while it awaits installation on the site of a solar farm.

The advantages of preassembling the structures 10 in a construction workshop 18 are many: the components needed for assembly are conveyed to a single point, namely the workshop, making it possible to optimize component transport costs. Moreover, the movements of the technicians dedicated to assembly are also optimized because these technicians need to operate only in their assembly zone Z₁, Z₂ or Z₃. The number of operations per assembly zone is also reduced, thereby optimizing productivity and reducing assembly errors.

The workshop has been described in relation to the assembly of a structure comprising two pedestals. Of course, it is possible also to envision a workshop adapted to the preassembly of structures each comprising more than two pedestals. In such a case, it is appropriate to provide, for preassembly, as many carriages as the structure has pedestals. The various zones of the workshop will also need to be connected by as many runway tracks as there are carriages, the initial assembly zone will need to comprise a corresponding number of first workstations, and the second assembly zone will need to comprise as many locations as there are carriages so as to ensure the distance between each of the arches of the pedestals of the structure.

Installation for a Free Field Solar Power Plant Site

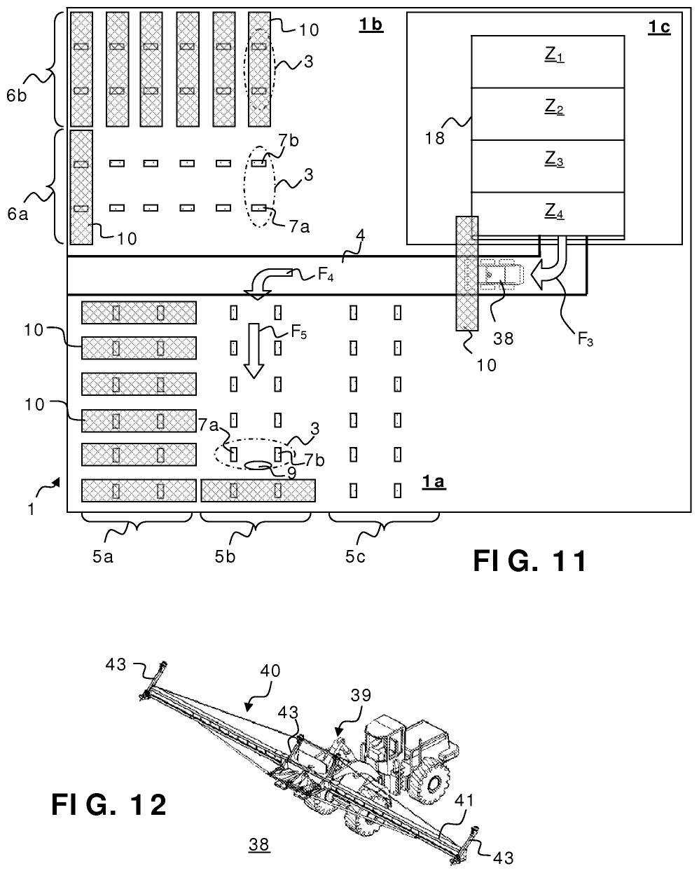

One possible embodiment of an installation for a free field solar power plant site according to the invention will now be described with reference to FIGS. 11 to 13.

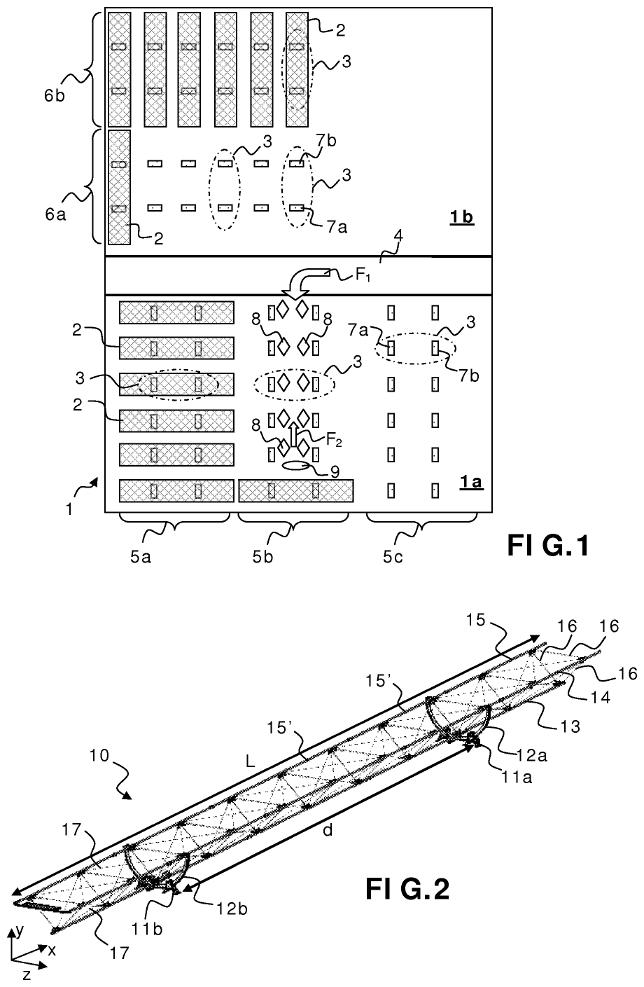

The site 1 depicted in a view from above in FIG. 11 is similar to the solar farm under construction described with reference to FIG. 1. Therefore, this site 1, once again has the two installation zones 1a and 1b separated by a runway track 4. Unlike in FIG. 1, the solar tracker structures that are to be installed on the dedicated locations 3 of the site 1 are the preassembled structures 10 with two pedestals as described hereinabove. The site 1 is depicted in the same state of progress with installation as the solar farm of FIG. 1, namely:
for the installation zone 1a: all the tracker structures 10 have already been installed for row 5a, just one structure has been installed in row 5b and no structure has yet been installed in row 5c;
for the installation zone 1b: all the tracker structures 10 have already been installed for row 6b, and just one structure has been installed in row 6a.

In addition to the two installation zones 1a, 1b, the installation also comprises a zone 1c which, at least temporarily, accommodates a construction workshop such as the construction workshop 18 described hereinabove with its three assembly zones Z₁ to Z₃ and its storage zone Z₄. The installation zones 1a, 1b for the structures 10 preassembled in the workshop 18 are connected to the workshop 18, preferably on the side of the storage zone Z₄, by the on-ground runway track 4.

The installation further comprises at least one transport and lifting implement 38 configured to transport, via the on-ground runway track 4, a preassembled structure 10 from the construction workshop 18 as far as the pair of foundations 7a, 7b of the location 3 dedicated to that structure 10.

The transport and lifting implement 38 is also able to place the preassembled structure 10 directly on this pair of foundations 7a, 7b so that the first pedestal (which, as described hereinabove, comprises the cradle 11a and the first support arch 12a) and the second pedestal (which comprises the cradle 11b and the second support arch 12b) of the preassembled structure 10 rest respectively on the first ground support 7a and the second ground support 7b of said pair of foundations. Just one individual (the operator of the transport and lifting implement 38) is needed to convey a structure preassembled in the workshop as far as its location 3, as indicated schematically by the arrows F₃ to F₅ in FIG. 11. A crew 9 of technicians can then intervene to fix the structure 10 to the foundations and complete the assembly of the solar tracker (fit the photovoltaic panels, the wiring, etc.).

Transport and Lifting Implement

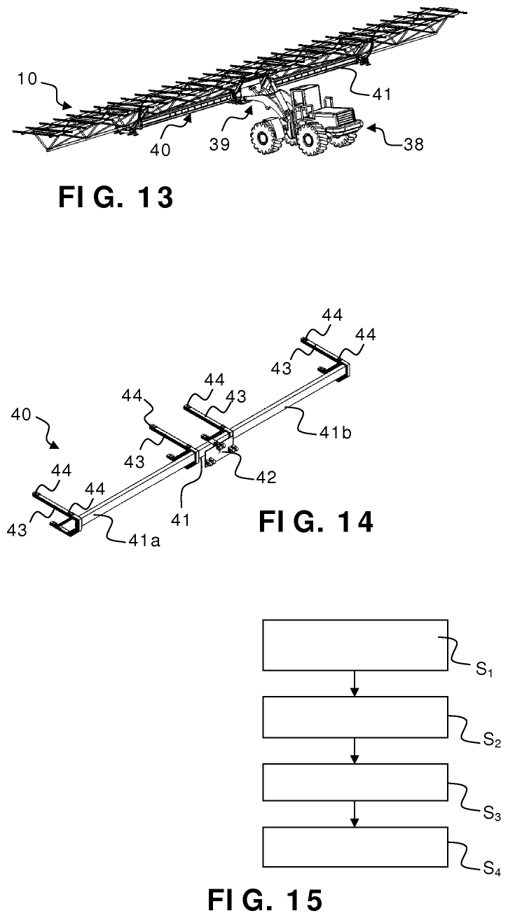

FIG. 12 depicts one example of a transport and lifting implement 38 particularly well suited to collecting a structure that has been preassembled in the workshop 18 (preferably while this structure is still being supported by the two carriages used for assembling it), conveying this structure substantially horizontally (in the case of a horizontal runway track 4) as far as its dedicated location 3, and setting the structure down directly on the foundations of this dedicated location. FIG. 13 illustrates another view of the transport and lifting implement 38 in the process of transporting a preassembled structure 10 substantially horizontally.

The implement 38 is a motorized vehicle of the tractor type, comprising an articulated and telescopic front arm 39 which at its front end bears a member 40 that acts as the interface between the implement 38 and each preassembled structure 10 that is to be transported. As is more particularly visible in FIG. 14 which depicts the member 40 alone, this member chiefly comprises a transverse bar 41 equipped in the middle of its rear region with a connecting plate 42 for attaching it to the front end of the front arm 39 of the implement 38. The transverse bar 41 bears four forks 43 extending forward perpendicular to the transverse bar 41, the forks 43 being able to slip into four coupling zones (not depicted) of the structure 10. Clamping means 44 are provided on each of the forks 43 to ensure that the preassembled structure 10 is securely held while it is being transported by the transport and lifting implement 38. The transverse bar 41 is dimensioned to extend preferably over a little more than half the length of the preassembled structure 10.

The telescopic and articulated front arm 39 is preferably configured to allow the transported structure to be raised to a sufficient height (typically 2.5 meters) that if necessary it can pass over the top of a solar tracker already installed on the site. Furthermore, the transverse bar 41 may advantageously be made up of two arms 41a, 41b that are articulated in such a way as to be able to be folded back along the sides of the implement 38. This allows the implement 38, when returning empty to the workshop 18, to pass another, oncoming implement 38 if necessary.

Method for Installing Solar Trackers

FIG. 15 illustrates steps that can be implemented for a method for installing solar trackers on a free field solar power plant site, for example the site 1 of FIG. 11.

The method comprises:
a phase S₁ of installing a workshop for the construction of preassembled structures on a dedicated zone 1c of the site 1, for example the workshop 18 described hereinabove;
a phase S₂ of constructing preassembled structures 10 for solar trackers in the construction workshop 18;
a phase S₃ of constructing a plurality of locations 3 in a solar tracker installation zone connected to said construction workshop 18 by at least one on-ground runway track 4, each location 3 comprising foundations on the ground forming ground supports 7a, 7b, which ground supports are able respectively to receive the first pedestal (comprising, as described hereinabove, the cradle 11a and the first support arch 12a) and the second pedestal (comprising the cradle 11b and the second support arch 12b) of a structure 10 preassembled in said construction workshop 18; and
a transport and installation phase S₄ during which a preassembled structure 10 is transported from the construction workshop 18 and placed directly on the foundations of a location 3 by the one same lifting and transport implement 38 which is able to position the first pedestal and the second pedestal of the preassembled structure 10 on the ground supports 7a and 7b.

Although FIG. 14 shows successive phases S₁ to S₄ in a certain order, it will be appreciated that the order of phases S₁ and S₃ may be reversed. The phases of installing the workshop (phase S₁) and of constructing the foundations (phases S₃) may also be performed in parallel without departing from the scope of the present invention.

1. A workshop for the construction of preassembled structures for solar trackers, each preassembled structure having, on the one hand, a support beam extending along a longitudinal axis and configured to support a table equipped with solar energy collecting devices and, on the other hand, at least two lower parts forming at least a first pedestal and a second pedestal and respectively comprising a first support arch and a second support arch which are configured to support said support beam, the first support arch and the second support arch each extending in a plane perpendicular to said longitudinal axis and being separated from one another by a predetermined inter-arch distance d,
the construction workshop comprising:
at least two successive assembly zones, and
at least a first carriage and a second carriage which are able to be moved along the ground in the construction workshop for constructing the one same preassembled structure, along, respectively, a first path along a first runway track and a second path along a second runway track, the runway tracks connecting said at least two successive assembly zones, and in that the successive assembly zones have:
an initial assembly zone having, on the one hand, a first workstation to allow the first pedestal to be assembled directly on said first carriage, the first pedestal after assembly being oriented in such a way that the first support arch extends in a vertical plane parallel to the first path and, on the other hand, a second workstation to allow the second pedestal to be assembled directly on the second carriage, the second pedestal after assembly being oriented in such a way that the second support arch extends in a vertical plane parallel to the second path; and
a second assembly zone having a first location on the first path of the first carriage and a second location on the second path of the second carriage, these locations being configured to hold the first carriage and the second carriage respectively in position for assembling the support beam to the first support arch and to the second support arch which are borne respectively by the first carriage and the second carriage, the first and second locations being distant from one another so that when the first carriage and the second carriage are respectively occupying the first and second locations, the first support arch and the second support arch extend in two vertical planes which are separated from one another by said predetermined inter-arch distance d.

2. The workshop as claimed in claim 1, wherein said workshop comprises a first pair of rails and a second pair of rails extending respectively over at least the first location and the second location of the second assembly zone, and in that the first carriage or, respectively, the second carriage, comprises a first set of wheels which are able to collaborate with the first pair or, respectively, the second pair, of rails to guide the first carriage or, respectively, the second carriage, over the first location or, respectively, the second location.

3. The workshop as claimed in claim 2, wherein the first pair of rails and the second pair of rails extend as far as the initial assembly zone, the first carriage and the second carriage respectively bearing the first pedestal and the second pedestal which are assembled in the initial assembly zone being able to be moved directly as far as the first location or, respectively, second location of the second assembly zone by rolling along their associated pair of rails.

4. The workshop as claimed in claim 2, wherein the first carriage or, respectively, the second carriage, comprises a second set of wheels to allow the carriages to roll along the ground of the workshop when not rolling along their associated pair of rails.

5. The workshop as claimed in of claim 2, wherein, with the support beam of each preassembled structure being a latticework beam comprising three longitudinal members extending in a parallel manner along said longitudinal axis, the second assembly zone comprises a plurality of longitudinal-member support tools distributed on either side of the first location and of the second location along an axis perpendicular to the pairs of rails, each support tool being able to preposition and temporarily hold three sections of longitudinal members in an orientation perpendicular to the pairs of rails.

6. The workshop as claimed in claim 5, wherein each longitudinal-member support tool comprises a U-shaped support piece, which is to say a piece comprising two parallel uprights connected by a horizontal middle branch perpendicular to these.

7. The workshop as claimed in claim 6, wherein said U shaped support piece is mounted with the ability to pivot on at least one pedestal so as to be able to pivot between a raised position in which the two uprights stand up vertically, and a lowered position in which the two uprights extend substantially horizontally.

8. The workshop as claimed in claim 7, wherein the free ends of the two uprights and the middle branch comprise a housing able to accommodate a section of one of the three longitudinal members when the U-shaped support piece is in the raised position.

9. The workshop as claimed in claim 1, wherein said workshop comprises a third assembly zone, contiguous with said second assembly zone and toward which the first carriage and the second carriage respectively bearing the first pedestal and the second pedestal assembled in the initial assembly zone, and the support beam assembled in the second assembly zone can be moved by rolling simultaneously along the first runway track and the second runway track.

10. The workshop as claimed in claim 1, wherein said workshop comprises a storage zone toward which the first carriage and the second carriage bearing a preassembled structure can be rolled simultaneously.

11. An installation for a free field solar power plant site, said installation comprising:
a workshop for the construction of preassembled structures for solar trackers as claimed in claim 1;
a solar tracker installation zone connected to said construction workshop by at least one on-ground runway track for running along the ground, said installation zone comprising a plurality of locations, each location comprising at least two foundations on the ground forming a first ground support and a second ground support which are able respectively to receive a first pedestal and a second pedestal of a structure preassembled in said construction workshop; and
a lifting and transport implement configured to transport, via said at least one on-ground runway track, a preassembled structure from the construction workshop as far as the installation zone and for placing said preassembled structure directly on the at least two foundations of a location so that the first pedestal and the second pedestal of the preassembled structure rest respectively on the first ground support and the second ground support.

12. A method for installing solar trackers on a site of a free field solar power plant, comprising:
a phase of installing a construction workshop as claimed in claim 1 on a dedicated zone of said site;
a phase of constructing preassembled structures for solar trackers in said construction workshop;
a phase of constructing a plurality of locations in a solar tracker installation zone connected to said construction workshop by at least one on-ground runway track, each location comprising at least two foundations on the ground forming a first ground support and a second ground support, which ground supports are able respectively to receive the first pedestal and the second pedestal of a structure preassembled in said construction workshop; and
a transport and installation phase during which a preassembled structure is transported from the construction workshop and placed directly on the at least two foundations by the one same lifting and transport implement which is able to position the first pedestal and the second pedestal of the preassembled structure on the first ground support and the second ground support respectively.
